(19) United States
(12) Patent Application Publication
(10) Pub. No.: US 2024/0086858 A1
(43) Pub. Date: Mar. 14, 2024

(54) SYSTEM AND METHOD FOR FACILITATING BUILDING INSPECTIONS

(71) Applicant: TOWN & COUNTRY BUILDING PTY LTD, Cobargo, NSW (AU)

(72) Inventor: Ben COWDROY, Cobargo, NSW (AU)

(21) Appl. No.: 18/260,840

(22) PCT Filed: Jan. 11, 2022
(86) PCT No.: PCT/AU2022/050008

§ 371 Date: Jul. 10, 2023

(30) Foreign Application Priority Data
Jan. 11, 2021 (AU) 2021900039

(51) Int. Cl. G06Q 10/1093; G06Q 50/08

(52) U.S. Cl. CPC G06Q 10/1097; G06Q 50/08

(57) ABSTRACT

The present invention provides a computer-implemented system that facilitates the performance of a building inspection, the system including one or more processors in communication with one or more devices associated with a building inspector, the one or more processors configured to receive information regarding a building inspection, the information including a building inspection agreement describing at least the purpose of the building inspection accessible by the building inspector through use of one or more devices associated with the building inspector, one or more databases in communication with the one or more processors configured to store details pertaining to a plurality of modules with each module relevant to a particular aspect of a building inspection, the one or more processors further configured to receive at least the following inputs from the one or more devices associated with the building inspector, including, a selection of one or more modules from the plurality of modules relevant to a forthcoming building inspection, any one or more of notes, parameter selections, images and/or sound recordings regarding the forthcoming inspection, and one or more parameters for tailoring the format of one or more building inspection reports to accord with the requirements of one or more intended recipients of the one or more building inspection reports, the system further configured to receive input from the building inspector whilst conducting an inspection of the building from the one or more devices associated with the building inspector, the input including any one or more of further notes, parameter selections, images and/or sound recordings, generate building inspection reports for the intended recipients that accord with a tailored format configured for each intended recipient, and subsequent to generation of the one or more building inspection reports, transmit the one or more building inspection reports to the one or more intended recipients upon instruction of the building inspector and/or one or more other users.

### FIELD OF THE INVENTION

The present invention relates to a computer-implemented system and method for performing building inspections. The present invention also relates to a computer-implemented system and method for generating building inspection reports, and in particular, generating a plurality of building inspection reports each tailored to particular inspection requirements according to the requirements of various parties such as real estate agents, landlords, financial (lending) institutions and/or prospective purchasers of a property.

### BACKGROUND OF THE INVENTION

There are numerous scenarios that require the performance of a building inspection with respect to a property. Such scenarios include the prospective purchase of a property by a buyer, the refinancing of a property mortgage by a property owner, the prospective sale of a property by a property owner, or when a property needs to be inspected to ascertain whether it meets building standards and regulations and/or safety requirements.

Depending upon the purpose, a building inspection can be quite complex and may contain many aspects that must be thoroughly completed, checked, and/or documented. Types of information that may require documenting include, for example:
any identified hazards or safety issues, such as structural issues or the presence of asbestos;
a detailed description of any defects and/or issues that may require future or ongoing property maintenance;
information regarding detection of the presence of termites/timber pests and/or other pest infestations;
a review of any conditions that are conducive to attracting and/or assisting the growth and spread of termite/pest infestation;
recommendations including repair and/or maintenance associated with any detected issues;
information pertaining to compliance with regulatory requirements including building and planning requirements; and
images/photos as evidence of any identified problematic issues or hazards.

Whilst most building inspectors have professional indemnity insurance in the event one or more issues are missed and/or are incorrectly documented, a failure to correctly identify and report all issues can become a costly exercise for building inspectors as a result of reputational damage, and hence, loss of clients. Accordingly, there is a need for building inspectors to have access to tools and support to efficiently conduct a building inspection as comprehensively and accurately as required and report the outcome of same to those parties requiring a report satisfying the particular requirements of each party.

Generally, to create reports, most building inspectors either create their own templates or adapt templates that are available from various sources including sources online. Such templates provide a standard generalized format and include standard disclaimers. However, due to the generality of their formats and a lack of the facility to customize available templates to suit the particular purpose of a particular inspection and/or the particular requirements of a particular recipient of a building inspection report (for example, a real-estate agent, a property owner, or a prospective purchaser of a property), such templates are either not useful, or require detailed revision to conform them to the specific purpose for which the template has been obtained.

There are currently various online programs or computer applications accessible by building inspectors for the generation of reports. However, such online programs and computer applications lack the ability for customization and/or are difficult to use. Currently available computer-implemented systems and software applications are also problematic regarding the transfer of data to/from data repositories during use. Since most building inspections are generally conducted by an inspector using a mobile device connected to a data communications network generally occurs and during an inspection, inefficient use of a data communications network is problematic.

The present invention seeks to mitigate the problems associated with existing computer-implemented functionality and platforms for the generation of building inspection reports, or at least seeks to provide an alternative solution to existing methods, online programs and computer applications for generating building inspection reports.

The reference to any prior art in this specification is not, and should not be taken as, an acknowledgement or any suggestion, that the prior art forms part of the common general knowledge.

### SUMMARY OF THE INVENTION

In one aspect, the present invention provides a computer-implemented system that facilitates the performance of a building inspection, the system including one or more processors in communication with one or more devices associated with a building inspector, the one or more processors configured to receive information regarding a building inspection, the information including a building inspection agreement describing at least the purpose of the building inspection accessible by the building inspector through use of one or more devices associated with the building inspector, one or more databases in communication with the one or more processors configured to store details pertaining to a plurality of modules with each module relevant to a particular aspect of a building inspection, the one or more processors further configured to receive at least the following inputs from the one or more devices associated with the building inspector, including, a selection of one or more modules from the plurality of modules relevant to a forthcoming building inspection, any one or more of notes, parameter selections, images and/or sound recordings regarding the forthcoming inspection, and one or more parameters for tailoring the format of one or more building inspection reports to accord with the requirements of one or more intended recipients of the one or more building inspection reports, the system further configured to receive input from the building inspector whilst conducting an inspection of the building from the one or more devices associated with the building inspector, the input including any one or more of further notes, parameter selections, images and/or sound recordings, generate building inspection reports for the intended recipients that accord with a tailored format configured for each intended recipient, and subsequent to generation of the one or more building inspection reports, transmit the one or more building inspection reports to the one or more intended recipients upon instruction of the building inspector and/or one or more other users.

In an embodiment, the system automatically tailors the format of the one or more building reports on the basis of the selection of the one or more modules by the building inspector and input regarding the one or more parameters submitted by the building inspector in combination with an analysis of the information regarding a forthcoming building inspection, the notes, parameter selections, images and/or sound recordings provided by the building inspector using one or more artificial intelligence techniques.

In an embodiment, the one or more artificial intelligence techniques may include, but are not limited to, natural language processing of the information regarding a forthcoming building inspection, notes and parameter selections, image recognition of the recorded images relevant to the inspection and voice recognition applied to sound recordings. It will be appreciated that known artificial intelligence techniques may be used to significantly automate the tailoring of the format of the one or more building reports.

Automatically tailoring the one or more building inspection reports avoids the need for a building inspector to review and sort through substantial amounts of information to identify and select information relevant to a particular building inspection. In addition, the automatic tailoring of the one or more building inspection reports also facilitates the generation of more comprehensive building inspection reports and reduces the risk of omitting important information in a report. It will also be appreciated that by presenting a building inspector with an automatically tailored building report avoids requiring the building inspector to search through substantial amounts of information and/or completing and storing (saving) unnecessary information which thereby conserves computer processing and memory resources in addition to data communications network resources which may otherwise be required by transferring all information/modules to a building inspector even in the event various information/modules were not required for a particular inspection.

The one or more users may include, but are not limited to, government bodies such as local Councils, real-estate agents, financial Institutions, property owners, property investors, property sellers or any group or individual having an interest in obtaining a building inspection.

The one or more devices may include, but are not limited to, smart devices, computer tablets, computer desktops or any device operable to download, and interface with the system application of the present invention.

In an embodiment, the system may be further configured to enable a user device associated with each of the one or more other users to interface with the system and thereby access the information associated with the intended building inspection and inputs of the building inspector associated with the building inspection upon completion of the building inspection and/or as the building inspection progresses.

In an embodiment, the system may be configured to enable communication between the one or more devices of the building inspector and one or more other devices of the one or more other users substantially in real-time. In this regard, it will be appreciated that in the event there is some issue with the inspection, or the building inspector requires clarification from one or more of the other users with respect to an issue, the building inspector may communicate (i.e. by generating and sending a notification through the system application) to any one or more of the other users having an interest in the building inspection. By way of example, the one or more users may include, for example, a potential purchaser requesting a building inspection of a property of interest and the real-estate agent responsible for managing the sale of that property. An example issue may be an inability of the building inspector to gain access to the property at the scheduled inspection time. It will be appreciated that any notification generated and sent using the system application will automatically be stored by the system application, thereby resulting in a comprehensive record and timeline of any issues, incidents or actions that have occurred relating to the particular building inspection that may be retrieved at a later date.

In an embodiment, the system may be configured to enable the creation of forms which may be uploaded and stored in the one or more databases associated with the system application. Such forms may include, for example, requests for building inspections, requests and approval for access to a property or documentation that confirms a property to be inspected is safe to enter particularly if the property to be inspected is part of an active building site.

In an embodiment, the system may enable existing information stored in the system to be reviewed and/or approved substantially in real-time by the building inspector and/or the one or more other users.

In an embodiment, the system may further include calendar functionality configured to receive details of scheduled inspections and generate notifications to the building inspector and/or the one or more other users. It will be appreciated that such notifications may include any form of electronic reminder and include, but are not limited to, visual alarms, audible alarms, vibration alerts, short message service (SMS) texts and email received by the one or more devices of the building inspector and/or the one or more other users.

In an embodiment, the system may further include GPS location functionality and a timestamping facility to verify the location and time at which any image(s) are captured and/or included in a building inspection report. It will be appreciated that such functionality is particularly useful in the event of any future dispute between the relevant parties.

In an embodiment, the system may further be configured to interface with one or more regulatory information sources to update regulatory information stored in the one or more databases as a result of any changes in the regulatory information.

In another aspect, the present invention provides a computer-implemented method that facilitates the performance of a building inspection, the method including, receiving, by the use of one or more processors in communication with one or more devices associated with a building inspector, information regarding a building inspection, the information including a building inspection agreement that describes at least the purpose of the building inspection accessible by the building inspector through use of one or more devices associated with the building inspector, storing, by one or more databases in communication with the one or more processors, details pertaining to a plurality of modules with each module relevant to a particular aspect of a building inspection, receiving, by the one or more processors, at least the following inputs from the one or more devices associated with the building inspector, a selection of one or more modules from the plurality of modules relevant to a forthcoming inspection, any one or more of notes, parameter selection, images and/or sound recordings regarding the forthcoming inspection, and one or more parameters for tailoring the format of one or more building inspection reports to accord with the requirements of one or more intended recipients of the one or more building inspection reports, receiving input from the building inspector whilst conducting an inspection of the building from the one or more devices associated with the building inspector, the input including any one or more of further notes, parameter selections, images and/or sound recordings, generating, by the one or more processors, building inspection reports for the intended recipients that accord with a tailored format configured for the intended recipient, and subsequent to the generation of the one or more building inspection reports, transmitting the one or more building inspection reports to the one or more intended recipients upon instruction of the building inspector and/or one or more other users.

In another aspect, the present invention provides a computer-readable medium having a plurality of instructions executable by one or more processors of a computing device to perform the steps of, receiving, by the use of the one or more processors in communication with one or more devices associated with a building inspector, information regarding a building inspection, the information including a building inspection agreement describing at least the purpose of the building inspection that is accessible by the building inspector through use of one or more devices associated with the building inspector, storing, by one or more databases in communication with the one or more processors, details pertaining to a plurality of modules with each module relevant to a particular aspect of a forthcoming building inspection, receiving, by the one or more processors, at least the following inputs from the one or more devices associated with the building inspector, a selection of any one or more modules from the plurality of modules relevant to the forthcoming building inspection, any one or more of notes, parameter selections, images and/or sound recordings regarding the forthcoming inspection, and one or more parameters for tailoring the format of any one or more building inspection reports to accord with the requirements of one or more intended recipients of the one or more building inspection reports, receiving input from the building inspector whilst conducting inspection of the building from the one or more devices associated with the building inspector, the input including any one or more of further notes, parameter selections, images and/or sound recordings, generating, by the one or more processors, building inspection reports for the intended recipients that accords with a tailored format configured for each intended recipient, and subsequent to the generation of the one or more building inspection reports, transmitting the one or more building inspection reports to the one or more intended recipients upon instruction of the building inspector and/or one or more other users.

### BRIEF DESCRIPTION OF THE DRAWINGS

Embodiments of the invention will now be described in further detail with reference to the accompanying Figures in which:

FIG. 1 illustrates an exemplary system for facilitating the performance of building inspections and subsequent generation of a plurality of building inspection reports;

FIG. 2 illustrates the server component of the system of FIG. 1 that stores, inter alia, various pre-configured modules tailored to perform customised building inspections which are used to generate customised building inspection reports;

FIG. 3 illustrates an exemplary flow diagram depicting how a user (building inspector) uses and the system illustrated in FIG. 1 to configure the pre-configured modules according to their requirements and how to manage the inspection roster pertaining to their organisation;

FIG. 4 illustrates an exemplary flow diagram of a process that enables a user (building inspector) to download, install and subsequently login to their organisation's tenancy within the application for interacting with the system illustrated in FIG. 1;

FIG. 5 illustrates an exemplary flow diagram of a process that enables a user (building inspector) to view their inspection schedule and the details of their forthcoming inspections;

FIG. 6 illustrates an exemplary flow diagram of a process that enables a user (building inspector) to perform an inspection, capture additional information regarding the inspection and completing a report in respect of the inspection; and

FIG. 7 illustrates an exemplary flow diagram of a process that enables a user (building inspector) to perform an inspection, capture additional information regarding the inspection and complete a report in respect of the inspection.

### DETAILED DESCRIPTION OF EMBODIMENT(S) OF THE INVENTION

The present invention relates to a system and method for facilitating inspectors performing inspections and generating tailored reports with respect to the results of those inspections. In particular, the system and method includes the use of a range of configurable modules that may be used to instruct and record a broad range of inspection activities. The system and method further includes functionality that enables the generation of customised reports and transmission of same to various agencies including, for example, local Councils, real estate agencies, and financial institutions.

It will be appreciated that whilst the embodiments described herein relate to building inspections, the system and method may be used to perform a broad range of inspection activities including, for example, health and safety inspections, compliance inspections, hazard inspections, pest control inspections and valuation inspections etc.

According to an embodiment, the system and method of the present invention involves the steps of receiving and recording information associated with a plurality of building inspectors (180) associated with an organization (40) that perform building inspections and generate building inspection reports. The system and method according to an embodiment of the invention further includes the step of receiving information including one or more capabilities of each inspector and/or the availability of each inspector to perform various inspections (i.e., based on at least the time and location of a property that requires an inspection) and storing same in an inspector record database (50).

According to an embodiment, the system and method of the present invention includes the additional steps of storing a range of pre-configured inspection modules in a pre-configured module database (90) that an organization (40) and/or inspector (180) may tailor to their needs by creating a range of configured inspection modules relating to their industry. The configured inspection modules are also stored in a configured module database (70).

The creation of a database of pre-configured modules and making these available to an organization and/or inspector for tailoring to their specific needs, results in significant efficiencies associated with the generation of reports and in particular, authorized reports that seek to avoid the inclusion of irrelevant details in reports for particular recipients and generally increases the relevance and accuracy of the inspection and the reports generated. The system and method of the present invention also enables more efficient report generation and transmission of same to various interested parties (for example, real-estate agents, financial Institutions, property owners, property investors, property sellers or any group or individual having an interest in obtaining a building inspection with respect to a property). As will be appreciated by those skilled in the relevant field of technology, inappropriate selection and transfer of data results in a substantially inefficient use of computing resources and in particular, use of available data communications network bandwidth. As many more devices are connected to publicly available data communications networks for the purpose of trustworthy data, inefficient use of a network regarding data communications is becoming increasingly problematic.

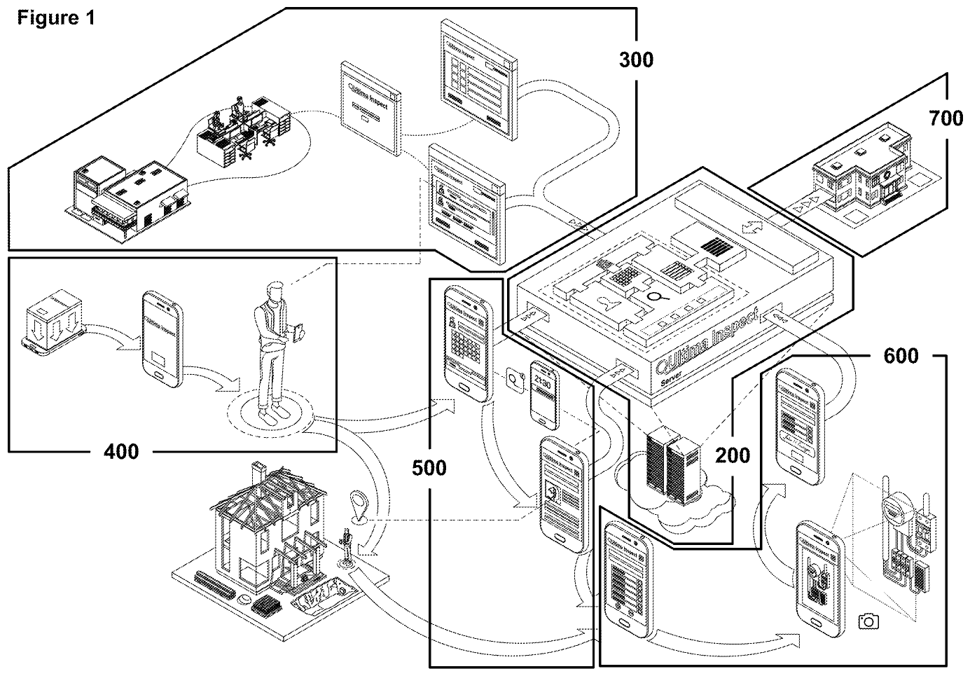

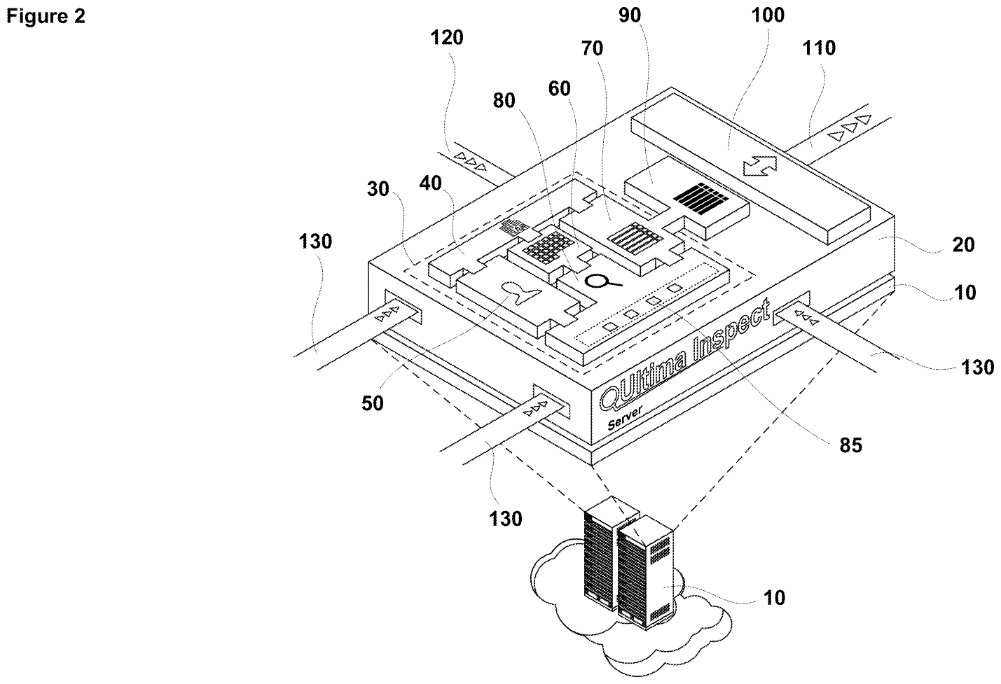

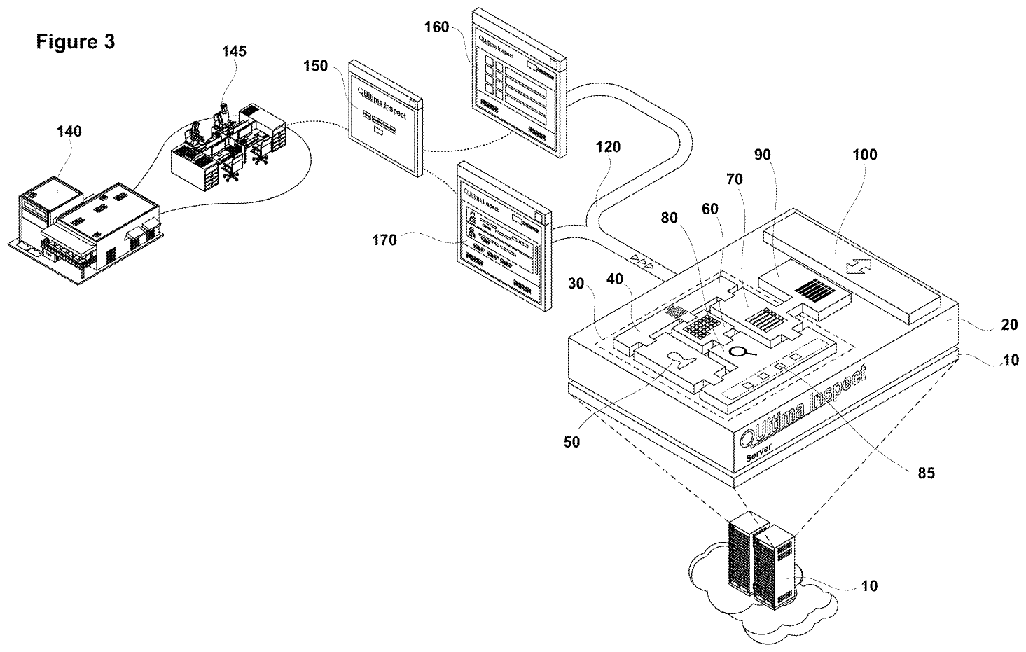

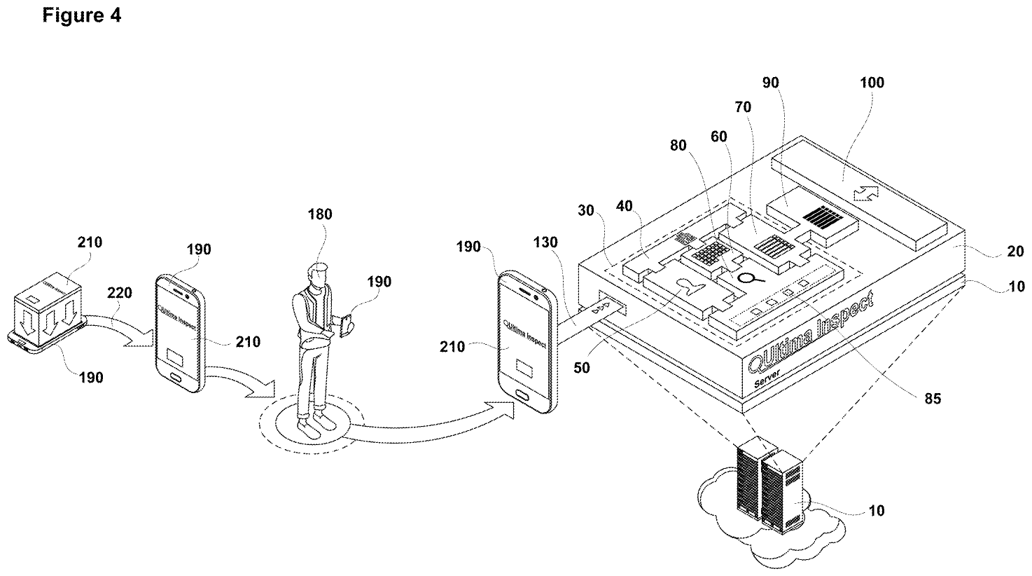

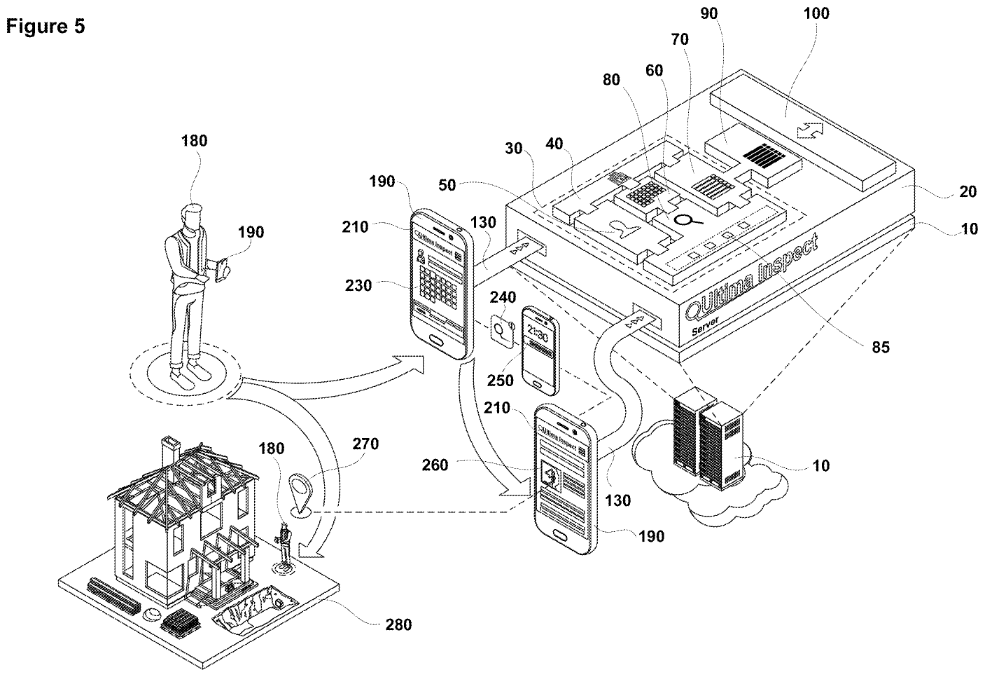

With reference to FIG. 1, which provides an overview of an embodiment the system and method of the present invention, it will be appreciated by skilled readers how the system and method seeks to address the technical problem described herein. FIG. 1 is divided into segments which are further expanded in subsequent FIGS. 2 to 7. In particular, segment 200 of FIG. 1 shows the server (20) with which a computer-implemented application (210) operating on a user device (190) is configured to communicate, which is further depicted in FIG. 2. Segment 300 of FIG. 1 shows how a tenancy (inspection organisation) (140) uses the application (210) to configure inspection modules based on the organisation's requirements and the organisation's inspection roster. This is further detailed in FIG. 3. Segment 400 of FIG. 1 shows a user (inspector) (180) downloading and installing the application (210) and logging into the application or registering as a new user. This is further detailed in FIG. 4. Segment 500 of FIG. 1 depicts the same user (180) viewing their inspection schedule and the details of forthcoming inspections using the application (210), which is further detailed in FIG. 5.

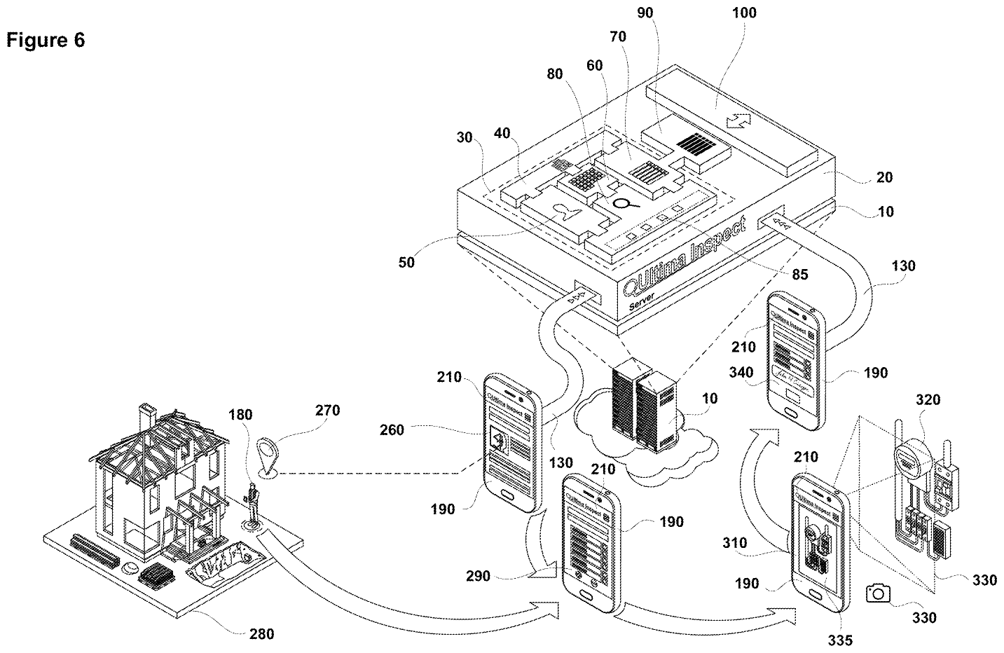

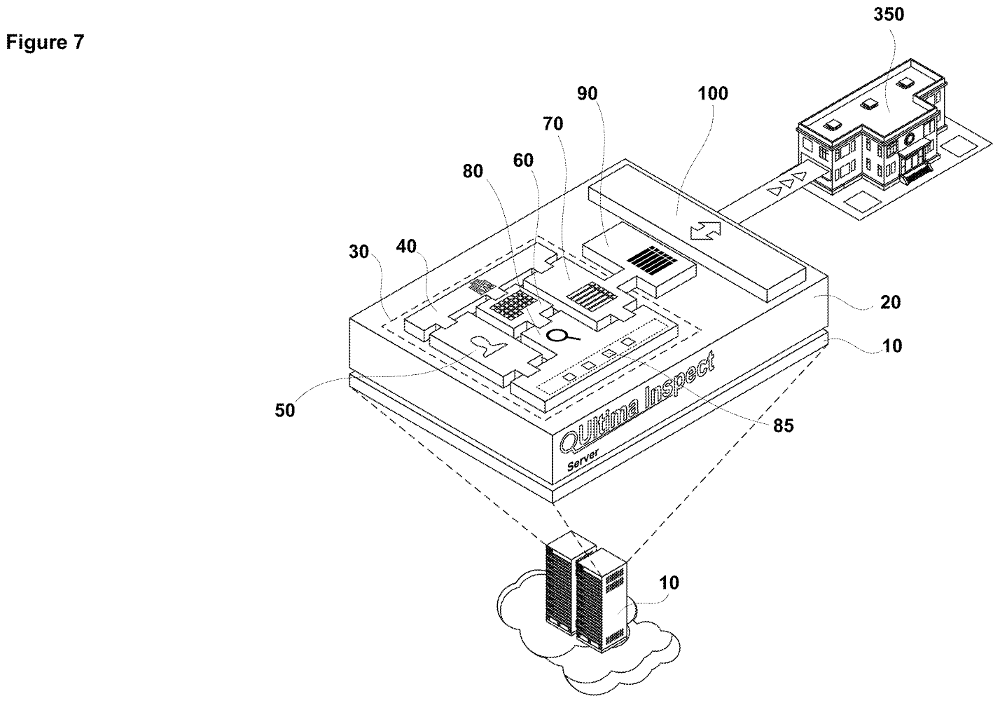

Segment 600, which is further detailed in FIG. 6, shows the same user (180) conducting a building inspection, capturing additional information regarding the inspection (e.g., photographs, voice recordings). Finally, segment 700 of FIG. 1 shows the transmission of a generated inspection report to one or more intended recipients including, for example, local Councils, Real estate agents, Financial Institutions, which is further detailed in FIG. 7.

FIG. 2 depicts in greater detail segment 200 of FIG. 1. In particular, FIG. 2 shows the server component (20) which includes the infrastructure (10) upon which the depicted embodiment of the present invention operates. The central server (20) stores information and data in one or more databases, and the infrastructure (10) may be local or cloud-based. It will become apparent that users may access the server (20) using user devices (190), such as mobile devices, or any browser application via the internet or a similar data communications network as described in greater detail below.

The central server (20) may include one or more computer applications that provide functionality including, but not limited to:
storage of information in, or access to, an organisation database (30) including:
   records (40) in respect of each organisation that subscribes to, or who use, the application (210). Such details including, but not limited to, the name, address, Company Business Number and contact details of each organisation;
   records (50) of each inspector employed by, or otherwise associated with, each organisation listed within organisation database (30). Such information may include details regarding each inspector's competencies, geographic location, and availability to complete inspections;
   schedules (60) of forthcoming inspections with respect to each inspector based on inspector geographic location, availability and competencies;
   configured inspection modules (70) that each organisation has selected/created/modified to suit their requirements;
   records (80) of each inspection that is to be conducted (or that has been conducted) by an organisation. Information contained in records (80) may include, but are not limited to, location, time, date and purpose of the inspection. The information may also include the generated report regarding the inspection once conducted;
   supporting information (85) associated with each inspection. The supporting information may include, but is not limited to, notes, voice recordings and photographic images to support/verify the inspection results. The photographic images may also be timestamped and contain GPS location information to provide additional support/verification of the inspection results.
pre-configured inspection modules (90) available to organisations (140) and building inspectors (180) that may be configured to suit an organisation's requirements including the reporting requirements of various entities;
functionality to interface inspection data stored in inspection records (80) located within the organisation database (30) with interested parties (e.g., local councils, real estate agents, financial institutions) (350);
communication means (110) to enable receipt and transmission of data (e.g., inspection reports and supporting information, approvals etc.,) between interested parties (e.g., local Councils, real estate agents and financial institutions) (350) and central server (20);
communication means (120) to enable receipt and transmission of data between organisation staff/administrators (145) and central server (20);
communication means (130) to enable receipt and transmission of data between the application (210) installed on user (inspector) device (190) and the central server (20).

FIG. 3 shows in greater detail segment 300 of FIG. 1 and illustrates in the particular embodiment depicted how staff/administrators (145) within an organisation (140) that subscribes to the system application (120) may configure (select/create/modify) pre-configured modules according to the organisation's requirements. FIG. 3 also shows in greater detail how the staff/administrators may schedule and allocate forthcoming inspections to various inspectors (180) employed (or otherwise associated with) the organisation based at least in part upon each inspector's competencies, availability and geographic location. More particularly, staff/administrators (145) use application interface functionality (150) to access the system application (210) and more particularly, use the scheduling interface functionality (150) and inspection module interface functionality (160) to access schedules (60) and pre-configured modules (90) stored in the central server (20). Once the staff/administrators have access, they are able to schedule and transmit to the central server (20), using communication means (120), forthcoming inspections to a particular inspector (180) based on the inspector's recorded details including their availability, geographic location and competencies. The staff/administrators are also able to gain access, via communication means (120) to preconfigured modules (90) stored in central server (20) to configure (select/modify/create) inspection modules according to the organisation's requirements. Accordingly, the application (210) enables organisations to tailor inspection modules according to their requirements, or the requirements of their industry, and create highly customised and more accurate/comprehensive inspection reports. In this regard it will be appreciated that reports generated by the system and method of the present invention will be more accurate and comprehensive as compared with manual reports created by inspectors using standard inspection templates since inspectors will be guided by the information included in the report according to the modules selected on the basis of the organisation's requirements and/or industry requirements.

FIG. 4 depicts in greater detail segment 400 of FIG. 1 and illustrates how a user (e.g., a building inspector) (180) may download and install the application (210) on their mobile communication device (190) and subsequently login and/or register to use the application (210). A user (180) may install the application (210) on their device (190), and this may be achieved by downloading the application (210) from an Application store. A user (180) may create an account on the application (210), and the account may capture information sufficient to enable the user to be correctly identified. The process of installing the application (210) is indicated by arrow (220). Registration creates a new account for user (180) within the application (210), and as part of this process, users will typically be required to upload credentials such as name, address, and date of birth, as well as additional details about themselves including profile information, photo, location, and language capabilities. Once registered and added to the organisation's inspection roster, user (180) is able to login and access, via communication means (130) between system application (210) and central server (20), information regarding forthcoming inspections that have been allocated to themselves by their organisation based on their availability, competencies and geographic location.

FIG. 5 depicts in greater detail segment 500 of FIG. 1, showing in particular, how a user (inspector) can use the system application (210) installed on their user device (190) to review their scheduled inspections. To conduct such a review, the user (180) accesses the system application (210) using their mobile device (190) and accesses the inspection schedule interface (230). In this embodiment, system application (210) generates an application notification (240) regarding a forthcoming inspection relating to building (280) that has been allocated to user (180). A short message service (SMS) reminder is also sent to the mobile device (190) of user (180) as a reminder of the forthcoming inspection. Inspection schedule interface (230) also includes additional functionality that enables user (180) to review their inspection schedule (60) stored within the organisation database (30) located on central server (20).

User (180) may also review further details regarding the forthcoming inspection of the building (280) using the system application (210) located on their user device (190). In this regard, and with continued reference to FIG. 5, user (180) is able to navigate the application (210) to the “inspection detail” interface (260) that includes functionality enabling the user (180) to review further details in relation to the forthcoming inspection. Such further details include the type (purpose) of the inspection (e.g., valuation for a financial institution) and the location (270) of the inspection.

FIG. 6 depicts in greater detail segment 600 of FIG. 1, detailing in particular, how user (180) is able to conduct an inspection of building (280). It will be appreciated that the system application (210) guides the user (inspector) (180) regarding the required elements of the inspection by the configured inspection modules as tailored by the user's (180) organisation. In this way, there is less likelihood that elements of the inspection will be missed by inspector (180), since all of the required elements of the inspection are identified in the configured modules selected by the organisation according to the requirements of the particular inspection, the organisation's requirements and/or the industry.

To conduct the inspection of building (280), user (180) uses their mobile device (190) to navigate the system application (210) to the “conduct inspection” interface (290) that includes functionality enabling the user (180) to undertake an inspection by guiding them through the configured inspection modules. It will be understood that user (180) can indicate compliance (or otherwise) regarding various elements of the inspection and items of interest, for example, electrical wiring or meter installation (320), and record and transmit this information to central server (20) by the use of their mobile device (190). In order support the outcome/conclusions/findings of their inspection, user (180) may include additional information using “supporting information” interface (310) within the system application (210). Supporting information interface (310) includes functionality that enables user (180) to include additional information (e.g. images (photographs)) (335) elements of the inspection and any items of interest (320) and voice recordings. The photographic images (320) may be taken by the user with their mobile device (190) using “image” functionality (330) and timestamped for verification purposes. The images (320) may also contain global positioning satellite (GPS) information. Once an inspection report has been completed, user (180) may navigate to the “complete inspection” interface (340) within system application (210) that includes functionality enabling user (180) to electronically sign the inspection report once complete. This functionality also enables the inspection report to be automatically transmitted to various intended (interested) parties (e.g. local Councils, real estate agents and financial institutions) (350) upon the completion and electronic signing of the report.

FIG. 7 depicts in greater detail segment 700 of FIG. 1, showing how data (e.g., an inspection report) is transmitted via the data exchange interface (100) from the central server (20) to various intended (interested) parties, for example, financial institution (350). In embodiments, the system application contains functionality that automatically transmits data (e.g., a building report) to the various interested parties upon the request of user (180) or upon the request of any of the interested parties.

The user device (190) could be a tablet computer, a smartphone, a laptop computer, a desktop computer, or another type of computing device. The user device (190) may include a display that provides an interface for the user to input and/or view information. For example, a user could interact with the device using a program executed on a laptop computer, such as a text-based chat program, a voice-based communication program, and/or a video-based communication program. Alternatively, in some cases, the user device (190) could be a telephone (e.g. a landline, cell phone, etc.).

The central server (20) may be a single computer, the partial computing resources of a single computer, a plurality of computers communicating with one another, or a network of remote servers (e.g., cloud). The one or more servers can house local databases and/or communicate with one or more external databases.

The user device (190) may communicate with the server (20) over a network. In some embodiments, the network may be a wide area network (“WAN”), e.g., the Internet. In other embodiments, the network may be a local area network (“LAN”). For example, in a more remote location far from a metropolitan segment, the Internet may not be available. In yet other embodiments, the network may be a combination of a WAN and a LAN. In embodiments where the mobile device (110) is a phone (e.g., a landline or a cell phone), the communication may pass through a telecommunications network and/or a wide segment network.

It will be appreciated by persons skilled in the relevant field of technology that numerous variations and/or modifications may be made to the invention as detailed in the embodiments without departing from the spirit or scope of the invention as broadly described. The present embodiments are, therefore, to be considered in all aspects as illustrative and not restrictive.

Throughout this specification and claims which follow, unless the context requires otherwise, the word “comprise”, and variations such as “comprises” and “comprising”, will be understood to imply the inclusion of a stated feature or step, or group of features or steps, but not the exclusion of any other feature or step or group of features or steps.

1. A computer-implemented system that facilitates the performance of a building inspection, the system including:
one or more processors in communication with one or more devices associated with a building inspector, the one or more processors configured to receive information regarding a building inspection, the information including a building inspection agreement describing at least the purpose of the building inspection accessible by the building inspector through use of one or more devices associated with the building inspector;
one or more databases in communication with the one or more processors configured to store details pertaining to a plurality of modules with each module relevant to a particular aspect of a building inspection;
the one or more processors further configured to receive at least the following inputs from the one or more devices associated with the building inspector:
a selection of one or more modules from the plurality of modules relevant to a forthcoming building inspection;
any one or more of notes, parameter selections, images and/or sound recordings regarding the forthcoming inspection; and
one or more parameters for tailoring the format of one or more building inspection reports to accord with the requirements of one or more intended recipients of the one or more building inspection reports;
the system further configured to:
receive input from the building inspector whilst conducting an inspection of the building from the one or more devices associated with the building inspector, the input including any one or more of further notes, parameter selections, images and/or sound recordings;
automatically generate, based on either the selected one or more modules, the received input or both and performing an analysis of same using one or more artificial intelligence techniques, building inspection reports for the intended recipients that accord with a tailored format configured for each intended recipient; and
subsequent to generation of the one or more building inspection reports, transmit the one or more building inspection reports to the one or more intended recipients upon instruction of the building inspector and/or one or more other users.

2. The system according to claim 1, further configured to enable a user device associated with each of the one or more other users to interface with the system and thereby access the information associated with the intended building inspection and inputs of the building inspector associated with the building inspection upon completion of the building inspection and/or as a building inspection progresses.

3. The system according to claim 1, further configured to enable communication between the one or more devices associated with the building inspector and each of the devices associated with the one or more other users substantially in real-time.

4. The system according to claim 1, further configured to enable the creation of forms, and upload and maintain same in one or more databases associated with the system.

5. The system according to claim 1, further configured to enable existing information stored in the system to be reviewed and/or approved substantially in real-time by the building inspector and/or the one or more other users.

6. The system according to claim 1, further including calendar functionality configured to receive details regarding scheduled inspections and generate one or more notifications to the building inspector and/or the one or more other users.

7. The system according to claim 1, further including GPS location functionality and a timestamping facility to verify the location and time at which any image(s) are captured and/or included in a building inspection report.

8. The system according to claim 1, further configured to interface with one or more regulatory databases to update regulatory information stored in one or more databases as a result of any changes in the regulatory information.

9. A computer-implemented method that facilitates the performance of a building inspection, the method including:
receiving, by the use of one or more processors in communication with one or more devices associated with a building inspector, information regarding a building inspection, the information including a building inspection agreement that describes at least the purpose of the building inspection accessible by the building inspector through use of one or more devices associated with the building inspector;
storing, by one or more databases in communication with the one or more processors, details pertaining to a plurality of modules with each module relevant to a particular aspect of a forthcoming building inspection;
receiving, by the one or more processors, at least the following inputs from the one or more devices associated with the building inspector:
a selection of one or more modules from the plurality of modules relevant to the forthcoming inspection,
any one or more of notes, parameter selection, images and/or sound recordings regarding the forthcoming inspection, and
one or more parameters for tailoring the format of one or more building inspection reports to accord with the requirements of one or more intended recipients of the one or more building inspection reports;
receiving input from the building inspector whilst conducting inspection of the building from the one or more devices associated with the building inspector, the input including any one or more of further notes parameter selections, images and/or sound recordings;
automatically generating, by the one or more processors, based on either the selected one or more modules, the received input or both and performing an analysis of same using one or more artificial intelligence techniques, building inspection reports for the intended recipients that accord with a tailored format configured for the intended recipient;
and subsequent to the generation of the one or more building inspection reports, transmitting the one or more building inspection reports to the one or more intended recipients upon instruction of the building inspector and/or one or more other users.

10. The method according to claim 9, wherein a user device associated with each of the one or more other users is caused to interface with the system and thereby access the information associated with the intended building inspection and inputs of the building inspector associated with the building inspection upon completion of the building inspection and/or as the building inspection progresses.

11. The method according to claim 9, wherein communication between the one or more devices associated with the building inspector and each of the devices associated with the one or more other users occurs substantially in real-time.

12. The method according to claim 9, further including receiving, by the use of calendar functionality, details of scheduled inspections and generating one or more notifications to the building inspector and/or the one or more other users.

13. The method according to claim 9, further including verifying, by the use of GPS location functionality and a timestamping facility, the location and time at which any image(s) are captured and/or included in a building inspection report.

14. The method according to claim 9, further including interfacing with one or more regulatory databases to thereby update regulatory information stored in one or more databases as a result of any changes in the regulatory information.

15. A computer-readable medium having a plurality of instructions executable by one or more processors of a computing device to perform the steps of:
receiving, by the use of the one or more processors in communication with one or more devices associated with a building inspector, information regarding a building inspection, the information including a building inspection agreement describing at least the purpose of the building inspection that is accessible by the building inspector by the use of one or more devices associated with the building inspector;
storing, by one or more databases in communication with the one or more processors, details pertaining to a plurality of modules with each module relevant to a particular aspect of a forthcoming building inspection;
receiving, by the one or more processors, at least the following inputs from the one or more devices associated with the building inspector:
a selection of one or more modules from the plurality of modules relevant to the forthcoming building inspection,
any one or more of notes, parameter selections, images and/or sound recordings regarding the forthcoming inspection, and
one or more parameters for tailoring the format of one or more building inspection reports to accord with the requirements of any one or more intended recipients of the one or more building inspection reports;
receiving input from the building inspector whilst conducting inspection of the building from the one or more devices associated with the building inspector, the input including any one or more of further notes, parameter selections, images and/or sound recordings;
automatically generating, by the one or more processors, based on either the selected one or more modules, the received input or both and performing an analysis of same using one or more artificial intelligence techniques, building inspection reports for the intended recipients that accords with a tailored format configured for each intended recipient; and
subsequent to the generation of the one or more building inspection reports, transmitting the one or more building inspection reports to the one or more intended recipients upon instruction of the building inspector and/or one or more other users.
